(19) United States
(12) Patent Application Publication
(10) Pub. No.: US 2026/0030274 A1
(43) Pub. Date: Jan. 29, 2026

(54) SYSTEMS AND METHODS FOR GENERATING STRUCTURED CONVERSATIONAL AI CONTENT FROM UNSTRUCTURED AND STRUCTURED DATA SOURCES

(71) Applicant: Knowbl Inc, Northville, MI (US)

(72) Inventors: Sean Croskey, Canton, MI (US); Parker Hill, Reno, NV (US); Michael Laurenzano, Spring Hill, TN (US)

(73) Assignee: Knowbl Inc, Northville, MI (US)

(21) Appl. No.: 19/279,626

(22) Filed: Jul. 24, 2025

Related U.S. Application Data
(60) Provisional application No. 63/675,045, filed on Jul. 24, 2024.

(51) Int. Cl. G06F 16/3329; G06F 16/3332; G06F 16/334

(52) U.S. Cl. CPC G06F 16/33295; G06F 16/3332; G06F 16/3347

(57) ABSTRACT

A system and method are disclosed for generating conversational content from human-readable documents. The method includes receiving a document comprising unstructured or semi-structured content and extracting linguistic and layout features using a language model and layout analysis techniques. The document is segmented into atomic content blocks representing discrete semantic units. For at least one content block, a natural language question is generated using a neural model, and a corresponding answer is extracted or synthesized. An optional rephrasing step modifies the surface form of the question or answer while preserving semantic meaning. Each question-answer pair is reviewed using automated or human-in-the-loop mechanisms for accuracy and alignment. Approved content is stored in a structured repository along with metadata supporting traceability and deployment. The system supports enterprise-scale generation of high-quality conversational data for downstream applications such as chatbots, virtual assistants, and retrieval-based AI systems.

### CROSS-REFERENCE TO RELATED APPLICATIONS

This application claims the benefit of U.S. Provisional Application No. 63/675,045, filed 24 Jul. 2024, which is incorporated in its entirety by this reference.

### TECHNICAL FIELD

The present application relates generally to the fields of artificial intelligence, machine learning, and natural language processing. More specifically, the present application pertains to systems and methods for generating structured conversational content from unstructured and structured data sources using configurable AI-driven pipelines comprising content ingestion, segmentation, question generation, answer synthesis, rephrasing, and content review modules.

### BACKGROUND

Conversational AI (CAI) systems, including chatbots, virtual assistants, and intelligent query-response platforms, are increasingly deployed across enterprise, customer support, and knowledge delivery domains. These systems typically rely on structured content representations, such as intent-response pairs, frequently asked questions (FAQs), or dialog trees, to generate accurate and contextually relevant responses to user queries.

Preparing this structured content, however, remains a labor-intensive and error-prone process. Domain experts, conversation designers, and engineers must manually review human-readable data sources, such as product manuals, policy documents, internal knowledge bases, and spreadsheets, to identify relevant information, formulate potential questions, craft accurate answers, and apply stylistic or brand-aligned tone adjustments. Even when automated tools are used for indexing or tagging, they often lack the fine-grained semantic resolution required to produce coherent and trustworthy CAI content.

Additionally, current approaches are poorly suited to handle both unstructured content (e.g., paragraphs in a PDF) and structured content (e.g., pricing tables or configuration matrices), leading to fragmented pipelines or inconsistent outputs. Without intelligent segmentation of source material into self-contained content blocks, or the ability to generate and rephrase content dynamically, the quality and coverage of generated content can be limited. Moreover, there is often no robust framework to support content validation via human-in-the-loop or agentic review systems that can flag inaccuracies, hallucinations, or gaps in coverage.

Accordingly, there is a need for improved systems and methods that can automatically transform raw human-readable content into structured conversational content using configurable AI-driven pipelines. Such systems should intelligently segment content, generate question-answer pairs, apply stylistic rephrasings, and enable validation workflows to ensure, completeness, accuracy, tone alignment, and contextual fidelity.

### BRIEF SUMMARY OF THE EMBODIMENTS

In one embodiment, a method for improving a predictive accuracy of a machine learning-based automated response system includes: implementing, by one or more computer processors, a content data transformation phase comprising extracting a set of content features from a raw digital content item using a content feature extraction model; learning, via a segmentation module, a plurality of distinct hierarchies derived from the content features; deriving a compositional hierarchy based on a combination of the learned hierarchies; forming one or more atomic content blocks by performing an antecedent concatenation of embeddings from target and antecedent hierarchical levels; storing and indexing the atomic content blocks into a conversational AI (CAI) repository database; executing a query transformation phase by receiving a query at an automated conversational or search-query interface; transforming the query into embeddings; performing a content lookup within the CAI content repository database using the embeddings; retrieving atomic content blocks based on a completion of the content lookup; hyper-augmenting the query by concatenating the embeddings of the retrieved blocks to the original query embeddings; executing an inferencing phase by generating response inferences using one or more response models trained on semantic embeddings; and returning an automated response generated from the inferences to the interface.

In some embodiments, the lookup of CAI content includes locating atomic content blocks within the CAI content repository database by identifying sets of content embeddings associated with stored atomic content blocks, where the embeddings satisfy a vector similarity threshold when compared to the query embeddings.

In some embodiments, extracting the set of content features includes extracting a set of linguistic features from the raw digital content item, wherein the linguistic features comprise token-level embeddings derived using a pretrained language model.

In some embodiments, learning the plurality of distinct hierarchies includes learning a language hierarchy based on the extracted linguistic features from the raw digital content item.

In some embodiments, extracting the content features further includes extracting a set of layout features, including vectors of spatial positions, font attributes, and visual alignment indicators of tokens in the raw digital content item.

In some embodiments, learning the distinct hierarchies further includes learning a visual hierarchy from the extracted layout features associated with the raw digital content item.

In some embodiments, deriving the compositional hierarchy includes integrating both a language hierarchy and a visual hierarchy into a unified compositional hierarchy.

In some embodiments, each atomic content block comprises a question-and-answer (Q/A) pair derived from a corresponding atomic block, where the atomic block is formed by segmenting the digital content data into semantically coherent vector units using a segmentation model that evaluates linguistic embeddings, layout features, or structural markers.

In some embodiments, the content feature extraction model generates both token-level and layout-level feature embeddings from the raw content, wherein the embeddings include semantic vectors, bounding box coordinates, font characteristics, or visual alignment features.

In some embodiments, each atomic content block represents a complete semantic unit of vectors joined via antecedent relationships in the compositional hierarchy, and is sufficient to respond to a potential user query without requiring additional context.

In some embodiments, the raw content data transformation phase further includes generating, using a sequence-to-sequence model, a natural language question for each atomic content block, conditioned on the content of that block.

In some embodiments, the transformation phase further includes generating a corresponding natural language answer to the generated question using either a generative or extractive model conditioned on the block and its question.

In some embodiments, the transformation phase further includes rephrasing the generated question or answer using a style adaptation module, comprising a transformer-based model, based on one or more stylistic parameters associated with the automated response system.

In some embodiments, the transformation phase further includes rephrasing the atomic content blocks using a style adaptation module to generate CAI content that aligns with defined stylistic input parameters.

In some embodiments, the transformation phase includes selectively bypassing a question generation step when a structured label or annotation indicates a pre-authored question is present in the atomic content block.

In some embodiments, the transformation phase includes selectively bypassing an answer generation step by linking the generated question to an externally supplied canonical answer when the referenced document content contains a satisfactory answer.

In some embodiments, the transformation phase includes detecting that a confidence value for a model-generated question or answer falls below a predefined threshold, and in response, bypassing Q/A generation by retrieving fallback Q/A pairs from a curated library or triggering a review workflow that presents the low-confidence result and enables reviewer approval, rejection, or editing via an interface.

In some embodiments, the CAI content repository includes a vector index for storing and organizing embedding vectors associated with atomic content blocks and enabling similarity-based retrieval using metrics such as cosine similarity, dot product, or Euclidean distance.

In one embodiment, a computer system for improving the predictive accuracy of a machine learning-based automated response system includes one or more computer processors and memory storing a vector index structure configured to support hardware-accelerated retrieval. The memory stores instructions that, when executed, cause the system to perform the content data transformation phase, the query transformation phase, and the inferencing phase as described above to return automated response data to a user-facing interface.

In some embodiments, the content repository used by the system includes a vector index stored in memory that supports similarity-based retrieval of atomic content blocks based on selected vector distance metrics.

In one embodiment, a computer-implemented method for generating automated responses using hierarchical content representations includes: receiving raw digital content at a distributed query-response service; extracting semantic and structural features using a feature extraction module; generating one or more hierarchical content representations using a segmentation model; forming enriched content blocks based on contextual relationships in the hierarchy; storing the blocks in a similarity-search-enabled repository; receiving and embedding a user query; retrieving content blocks relevant to the query embeddings; generating an augmented query; submitting the augmented query to a response engine; and returning an automated response to a user interface.

In some embodiments, the automated response returned to the user includes a confidence score and provenance metadata that identifies the atomic content block used to generate the automated response.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example mixed-block flow diagram for transforming a query and generating a response inference using the transformed query in accordance with one or more embodiments of the present application;

FIG. 4 illustrates an example flow diagram for generating distinct hierarchies and a compositional hierarchy for producing an atomic content block in accordance with one or more embodiments of the present application; and

FIG. 5 illustrates a schematic of an exemplary structure of a compositional hierarchy in accordance with one or more embodiments of the present application.

### DESCRIPTION OF THE PREFERRED EMBODIMENTS

The following description of the preferred embodiments of the present application is not intended to limit the scope of the embodiments to these preferred embodiments, but rather to enable any person skilled in the art to make and use these embodiments of the present application.

### 1. System for Content Transformation & Response Retrieval

System 100 may be configured to transform human-readable input content into structured conversational AI (CAI) content for use in query-response systems, chatbots, and intelligent assistants. In one or more embodiments, system 100 may be implemented a cloud-based or remote service, implemented using a distributed network of computers. In such deployments, content ingestion, transformation, and query-response processing may be executed, in real-time or near real-time, across separate computing nodes, each computing node performing dedicated roles or functions described in system 100, such as content feature extraction, hierarchy learning, embedding generation, and response inference.

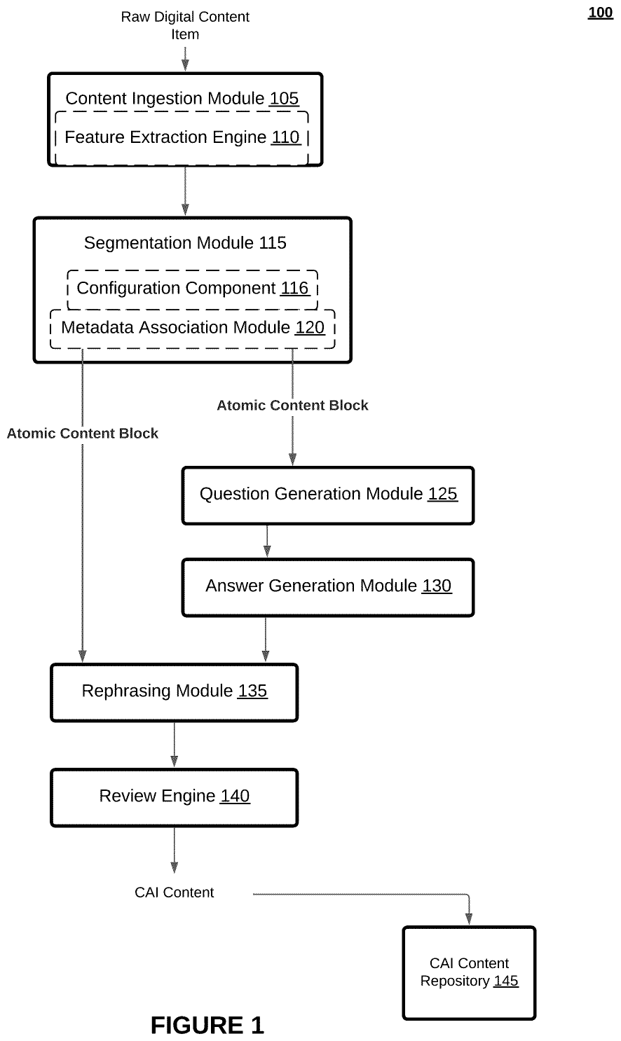

As shown in FIG. 1, System 100 may include a modular pipeline architecture that receives unstructured or structured data, such as textual documents, spreadsheets, webpages, or transcripts, and processes the data through a sequence of machine-learned components and logic-based operations. These components may include a Raw Content Ingestion Module 105, a (Content) Feature Extraction Engine 110, a Segmentation Module 115 with an optional (Segmentation) Configuration Component 116, a Metadata Association Module 120, a Question Generation Module 125, an Answer Generation Module 130, a Rephrasing Module 135, and a Review Engine 140. Finalized content may be stored in a (CAI) Content Repository 145 and optionally accessed by a downstream Query Inferencing Engine 150 to support real-time user interaction. Each component may be implemented as a software service, AI model, or API-accessible module, and the modular nature of System 100 allows for extensibility, fallback logic, and dynamic routing based on content type, domain, or confidence level.

### 1.05 Raw Content Ingestion Module

Raw content ingestion module 105 may be configured to receive one or more human-readable content items from various source formats including, but not limited to, DOCX files, PDF documents, HTML pages, plain text files, markdown, XML, and spreadsheet formats such as CSV or XLSX. In some embodiments, raw content ingestion module 105 may include parsers and adapters specific to each content type to normalize the layout, metadata, and structure of the ingested content. For example, a PDF parser may extract both textual content and layout features such as bounding boxes, font sizes, or page coordinates, while a spreadsheet parser may convert table cells into row-wise or column-wise representations preserving semantic associations between headers and values.

In certain implementations, raw content ingestion module 105 may include an optical character recognition (OCR) submodule configured to digitize scanned or image-based documents into machine-readable form. The ingestion module may also include a content stream preprocessor that removes control characters, extracts embedded hyperlinks, or preserves source-specific formatting tags such as bold, italic, or heading levels.

Raw content ingestion module 105 may output a normalized data structure comprising one or more token sequences, positional layout encodings, and associated document metadata. This output may be provided to content feature extraction engine 110 for downstream processing and feature derivation. The ingestion process may be executed synchronously or asynchronously, and may optionally support batching, queuing, or streaming interfaces for high-volume content pipelines.

In some variations, raw content ingestion module 105 may also detect the content language, document type, or domain classification using shallow heuristic models or embedded classifiers. These classification results may be embedded as metadata attributes and used to configure downstream modules including segmentation module 115 or question generation module 125.

### 1.10 Content Feature Extraction Engine

Content feature extraction engine 110 may be configured to generate intermediate representations of the ingested content by analyzing both its structural and semantic properties. The engine may operate on the normalized output produced by raw content ingestion module 105 and may compute one or more feature vectors or embeddings that encode layout, linguistic, and contextual attributes of the content.

In some embodiments, content feature extraction engine 110 may apply a multi-channel architecture in which visual layout features and linguistic features are processed in parallel or jointly. Visual layout features may include font size, indentation, boldness, column alignment, section headers, and spatial positioning. Linguistic features may include part-of-speech tags, named entity spans, syntactic parse trees, token frequency statistics, and contextual embeddings derived from pretrained language models such as BERT, ROBERTa, or LayoutLM. These features may be aggregated into token-level, sentence-level, or block-level representations, depending on the granularity required by downstream components.

Content feature extraction engine 110 may include one or more encoder models trained or fine-tuned to project textual spans into latent embedding spaces. In one example, a transformer encoder may process the tokenized content and generate contextualized token embeddings that capture inter-sentence dependencies and topical coherence. In another example, a vision-language model may incorporate layout cues as positional embeddings fused with token embeddings to produce layout-aware feature maps.

The output of content feature extraction engine 110 may include a set of content tokens with associated feature vectors, hierarchical structural metadata, and layout-aware encodings. These outputs may be passed to segmentation module 115 to support atomic content identification. In some implementations, content feature extraction engine 110 may also assign confidence scores or classification labels to specific content segments, such as predicting whether a section is a heading, paragraph, table, or figure caption.

In certain variations, content feature extraction engine 110 may support plugin-based models or adapter modules, enabling customization of the feature extraction process based on document type or content domain. This modular configuration allows the system to adapt to financial documents, policy statements, knowledge base articles, or instructional guides using domain-tuned encoders.

### 1.15 Segmentation Module

Segmentation module 115 may be configured to partition the ingested and feature-enriched content into discrete content segments, each representing a minimal, self-contained unit of information suitable for downstream generation tasks. These segments, referred to as atomic content blocks, may preserve semantic coherence while being sufficiently specific to support question generation and answer derivation. An atomic content block, as used herein, refers to a semantically coherent unit of content derived from raw digital content, wherein the unit is contextually enriched by embeddings concatenated from its antecedent levels in a compositional hierarchy. Atomic content blocks may comprise question-and-answer pairs or other content units configured for standalone semantic interpretability.

Segmentation module 115 may receive, as input, token sequences, layout metadata, and contextual embeddings produced by content feature extraction engine 110. The module may implement one or more machine learning models trained to identify logical boundaries between content units, such as paragraph breaks, topic shifts, or section transitions. In some embodiments, segmentation module 115 may apply sequence labeling models such as bidirectional long short-term memory (BiLSTM) networks with conditional random field (CRF) decoding, or transformer-based token classifiers such as fine-tuned BERT or ROBERTa models with segment-boundary prediction heads.

In certain implementations, segmentation module 115 may incorporate a hierarchical representation of the content by combining low-level visual cues and high-level linguistic structures. For example, layout-based models such as LayoutLM or document transformer encoders may integrate font size, indentation, and spatial grouping with semantic topic modeling to infer section-level or clause-level partitions. The resulting segment boundaries may be refined using rule-based heuristics or language modeling techniques to prevent semantic truncation or contextual ambiguity.

Segmentation module 115 may optionally support confidence scoring and soft boundaries, allowing for probabilistic or overlapping segmentation when appropriate. The output of segmentation module 115 may include a set of atomic content blocks, each associated with a set of tokens, a unique segment identifier, and a metadata object specifying the block's location, hierarchy level, and inferred topic label.

Segmentation module 115 may further include a configuration interface for enabling task-specific or domain-specific segmentation strategies. This configuration may be facilitated through segmentation configuration component 116, which may receive global settings, domain heuristics, or adaptive control parameters to modify segmentation behavior based on content type or operational context. For example, a financial spreadsheet may require row-level segmentation aligned with header cells, while a legal policy document may require clause-level segmentation guided by indentation and section markers.

In some cases, segmentation module 115 may produce outputs in both flat and hierarchical formats, supporting recursive or nested representations where one atomic content block may serve as a parent or container for other sub-blocks. These flexible representations may be preserved and propagated to metadata association module 120 to maintain structural traceability across the content transformation pipeline.

### 1.20 Metadata Association Module

Metadata association module 120 may be configured to assign semantic, structural, and contextual metadata to the atomic content blocks generated by segmentation module 115. The metadata may serve to inform downstream modules, such as question generation module 125 and answer generation module 130, of relevant contextual signals while maintaining traceability to the source material.

Metadata association module 120 may receive segmented content blocks along with their corresponding layout features, token-level embeddings, and hierarchical cues produced by earlier components. Within the module, a combination of rule-based logic, classification models, and embedding similarity techniques may be applied to infer and assign relevant metadata attributes. For example, a classification model may be used to assign content type labels such as definitions, instructions, or disclaimers based on token patterns or embedding space projections. In other implementations, a topic modeling process or semantic similarity function may determine an appropriate topic or subtopic for a given content block by comparing its vector representation to known labeled exemplars.

In certain embodiments, metadata association module 120 may identify a hierarchy level associated with each block, such as whether it appears within a section, subsection, or clause. This hierarchical information may be derived from font sizes, indentation, heading detection, or other visual features captured during ingestion and feature extraction. The module may also identify document-level attributes, such as the page number or file name from which a content block was extracted and store these attributes in a structured metadata schema for downstream consumption.

Additionally, metadata association module 120 may detect contextual dependencies between content blocks. For instance, a block that continues the semantic context of a prior block may be linked through a parent-child relationship. Similarly, enumerated sequences, conditional logic, or cross-references within a document may be captured through dependency metadata or traceability tags.

In some implementations, metadata association module 120 may also flag specific attributes associated with regulatory compliance, user prioritization, or domain-specific intent. For example, a financial policy document may include content blocks describing eligibility criteria, which the module may tag accordingly for priority treatment by question generation module 125. The assigned metadata may influence downstream generation logic, either as direct input to AI models or as filtering and sorting criteria during inference and review stages.

The output of metadata association module 120 may include a metadata-enriched version of each atomic content block, in which each block is paired with its respective structural, semantic, and contextual annotations. This enriched representation may be stored temporarily in memory or persisted in a document object structure before being passed to subsequent components within system 100.

### 1.25 Question Generation Module

Question generation module 125 may be configured to generate one or more natural language questions corresponding to atomic content blocks enriched with metadata from metadata association module 120. The generated questions may be used in downstream conversational AI applications such as chatbots, virtual agents, or query-response systems to facilitate user interactions aligned with the structure and meaning of the source content.

Question generation module 125 may receive, as input, a content block along with associated embeddings, topic labels, hierarchy information, and other metadata attributes. In some embodiments, the module may utilize one or more generative models, such as encoder-decoder transformers, trained or fine-tuned to produce interrogative sentences from source content. These models may include, for example, T5, FLAN-T5, BART, GPT variants, or custom transformer-based architectures optimized for enterprise domains.

During processing, question generation module 125 may first encode the input block using a language model encoder to produce a content embedding that captures both lexical and contextual properties. This embedding may be passed through one or more feedforward layers or attention-based decoders, optionally conditioned on metadata features such as topic type or content classification. The decoder may then generate a question token sequence using autoregressive decoding, beam search, or nucleus sampling, depending on the implementation.

In certain implementations, question generation module 125 may be configured to produce multiple candidate questions per content block, with each candidate emphasizing a different aspect of the block's content. The module may further include scoring logic to rank or filter the generated candidates based on fluency, completeness, or relevance to the source material. In some cases, semantic similarity metrics or cosine distance calculations may be used to eliminate redundant or low-utility questions.

Question generation module 125 may support fallback behavior or generation bypass logic when an atomic content block already includes a well-formed question or when metadata attributes indicate that question generation is unnecessary. For example, in the case of FAQ documents or existing help center content, the module may reuse the provided question and skip the generation phase altogether. In alternative cases, the module may operate in reverse, generating a question from an available answer when only an answer is detected in the input.

The output of question generation module 125 may include one or more natural language questions associated with each atomic content block, optionally ranked or annotated with quality scores or generation metadata. These questions may be passed to answer generation module 130, where responses may be generated, validated, or augmented based on the generated queries and their corresponding source content.

### 1.30 Answer Generation Module

Answer generation module 130 may be configured to generate natural language responses corresponding to one or more questions produced by question generation module 125, using the atomic content blocks and associated metadata as the contextual basis for generation. The generated answers may be concise, semantically aligned, and contextually faithful to the source content from which the questions were derived.

Answer generation module 130 may receive, as input, a pairing that includes a generated question and its corresponding content block, along with structural and semantic metadata produced by metadata association module 120. The module may be implemented using generative language models, such as transformer-based decoder architectures, capable of synthesizing fluent and contextually accurate answers from either extractive spans or abstractive reasoning across the input. Suitable models may include GPT variants, BART, UL2, FLAN-T5, Phi-2, or retrieval-augmented generation (RAG) architectures designed to leverage latent or explicit retrieval from the content block.

In some embodiments, answer generation module 130 may embed both the question and the content block using a dual-encoder or cross-attention encoder-decoder pipeline. The content block may be encoded to produce a dense embedding representing the scope and factual grounding of the answer space. The question may then be processed as an input prompt or conditioning vector that guides the decoder during answer generation. The model may perform decoding using autoregressive techniques, optionally enhanced by beam search, top-k sampling, or nucleus sampling strategies to ensure response diversity and syntactic correctness.

Answer generation module 130 may be configured to support multiple answer generation modes, including direct answer synthesis, extractive span selection, or a hybrid of both. In direct synthesis mode, the model may generate a response based on learned representations without copying content directly from the source. In extractive mode, the model may identify and reformat a span from the content block that directly answers the question. In hybrid mode, the model may use attention mechanisms or retrieval heuristics to anchor generated content to source passages while allowing limited abstraction or paraphrasing.

The module may also include scoring logic to evaluate the quality of the generated answer using metrics such as language fluency, entailment confidence, and factual consistency relative to the input content. In some implementations, hallucination detection mechanisms may be applied to assess whether a generated answer introduces unsupported claims or diverges from the original content. Such assessments may inform downstream review workflows or trigger fallback behavior, such as flagging for human validation.

The output of answer generation module 130 may include a validated or scored answer string for each generated question, paired with metadata such as the generation method, confidence score, or alignment trace to the input block. These outputs may be passed to rephrasing module 135 for further linguistic transformation or directly to review engine 140 for quality assurance.

### 1.35 Rephrasing Module

Rephrasing module 135 may be configured to generate one or more alternative surface forms of generated questions, answers, or question-answer pairs while preserving the underlying semantic intent. The module may operate on outputs produced by question generation module 125 and answer generation module 130 and may adapt the language for use in different conversational environments, user personas, or tone and style preferences.

Rephrasing module 135 may receive, as input, a natural language question, answer, or pair, along with optional metadata specifying rephrasing conditions such as stylistic tone, formality level, or delivery channel. For example, the module may be directed to rephrase an answer to reflect a sympathetic tone suitable for customer support interactions or a concise tone optimized for voice assistants. The module may also condition on platform-specific requirements, such as SMS character limits or chatbot message formatting constraints.

In some embodiments, rephrasing module 135 may be implemented using pretrained or fine-tuned generative language models, such as BART, GPT-3.5, GPT-4, FLAN-T5, or Mistral, with prompt engineering or prefix tuning to guide stylistic output. The model may embed the input content using an encoder, apply style-conditioning vectors or control tokens, and decode one or more alternative phrasings using autoregressive generation. The model may be configured to produce deterministic or stochastic outputs, depending on whether the rephrased content is intended for production use or candidate selection.

In certain implementations, rephrasing module 135 may generate multiple candidate variants for a given input. These variants may be evaluated using scoring functions that estimate linguistic fluency, semantic similarity to the original content, or stylistic adherence based on language model likelihoods or classifier predictions. A ranking function may then select the best candidate for inclusion in the conversational AI content repository or may forward multiple candidates to review engine 140 for human or agentic selection.

Rephrasing module 135 may also support bi-directional transformation workflows in which the system may restore previously rephrased content to its canonical form or detect deviation from an accepted baseline. In enterprise settings, this functionality may be used to enforce brand voice consistency or to adapt responses across multilingual deployments using translation-aligned rephrasing logic.

The output of rephrasing module 135 may include one or more alternate question, answer, or pair representations, each tagged with a rephrasing style label, model identifier, and traceable link to the original content. These rephrased outputs may be forwarded to review engine 140 for validation or directly stored in content repository 145 for downstream use.

### 1.40 Review Engine

Review engine 140 may be configured to perform quality assurance operations on generated conversational AI content, including questions, answers, and rephrased variants. The engine may operate in one or more modes, including fully automated validation, hybrid human-in-the-loop (HITL) workflows, or second-agent opinion reviews using independent language models. The purpose of review engine 140 is to ensure that generated outputs meet predefined standards of accuracy, clarity, consistency, and stylistic alignment before being committed to downstream systems or presented to end users.

Review engine 140 may receive as input one or more question-answer pairs, rephrased outputs, or raw generation artifacts from upstream components such as answer generation module 130 and rephrasing module 135. The module may also ingest associated metadata, including generation confidence scores, content provenance identifiers, topic classifications, and stylistic intent annotations. These inputs may be used to guide model-based evaluation or human review procedures.

In some implementations, review engine 140 may apply an automated review model configured to analyze the semantic coherence, factual correctness, and grammatical structure of the input content. This review model may be a large language model instance that operates independently from the models used for generation, such as a separate instance of GPT-4, Claude, or Gemini. The review model may be prompted with verification instructions and may return structured feedback, including pass/fail assessments, hallucination flags, tone mismatches, and revised candidates.

In certain configurations, review engine 140 may apply logical reasoning checks using chain-of-thought prompting or entailment analysis. For example, the engine may determine whether a generated answer logically follows from the content of the associated atomic content block or whether the question-answer pair introduces assumptions not present in the source material. The module may compute hallucination likelihood scores or generation divergence metrics and may use such signals to route questionable content to a human reviewer or to discard it from the workflow.

Review engine 140 may also include a user interface component that enables human reviewers to inspect generated content, approve or reject question-answer pairs, suggest edits, and provide feedback signals for retraining. This component may display content in context with original source material, highlight discrepancies or ambiguities, and capture reviewer actions and justifications. In enterprise deployments, review engine 140 may integrate with annotation platforms or content management systems to allow collaborative editing and audit tracking.

The output of review engine 140 may include a curated set of question-answer pairs and rephrased content marked as approved, flagged, or rejected, along with decision logs and confidence annotations. Approved content may be forwarded to content repository 145 for indexing and deployment. Flagged or ambiguous content may be recycled through upstream modules with updated parameters, routed to a secondary review agent, or subjected to additional training or reinforcement procedures.

### 1.45 Content Repository

Content repository 145 may be configured to store, organize, and make accessible the structured conversational AI content generated and validated by components of system 100. The repository may maintain associations between question-answer pairs, their originating content blocks, metadata, and any rephrased or stylistically adjusted variants. It may serve as the authoritative source of content for downstream query-response systems, virtual agents, or other conversational interfaces.

Content repository 145 may receive, as input, finalized content items approved by review engine 140, including validated question-answer pairs, annotated metadata, traceability references to the source content, and stylistic information. Each content item may be stored as a discrete record containing the original content block, one or more generated questions, corresponding answers, and any approved rephrasings. These records may be indexed using a combination of keyword-based, embedding-based, and metadata-based indexing strategies.

In some implementations, content repository 145 may maintain embedding vectors generated during feature extraction or answer generation, enabling vector-based semantic search during inference. Each stored content item may include one or more dense embeddings derived from transformer encoders such as Sentence-BERT, OpenAI embeddings, or Cohere models. These embeddings may be used to retrieve semantically relevant entries in response to natural language queries processed by query inferencing engine 150.

The repository may be organized using a hierarchical or faceted schema, allowing content to be grouped or filtered by topic, document section, content type, confidence level, or domain label. In certain configurations, content repository 145 may also store multiple versions of a content item, including original, rephrased, and human-edited variants. Version tracking and access control mechanisms may be implemented to ensure consistency, traceability, and governance of the stored content.

Content repository 145 may support one or more APIs or internal interfaces that enable batch retrieval, streaming access, or filtered queries based on intent, topic, or user persona. It may also support asynchronous update pipelines that allow newly ingested content or retrained generation outputs to be incorporated without service interruption. In some embodiments, content repository 145 may operate in conjunction with an external knowledge base or CMS system, synchronizing relevant content for multi-channel use.

The output of content repository 145 may be used directly by query inferencing engine 150 to serve real-time responses or to populate chatbot interfaces. The repository may also support analytics functions, such as tracking query coverage, measuring retrieval effectiveness, or identifying content gaps to inform retraining and augmentation cycles within system 100.

### 1.50 Query Inferencing Engine

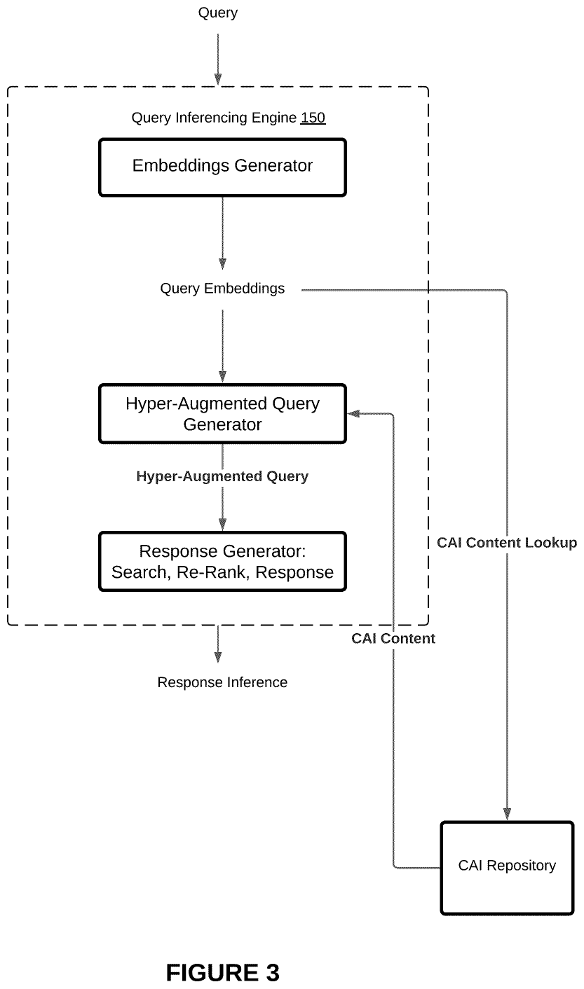

Query inferencing engine 150 may be configured to process natural language user queries and retrieve or generate appropriate responses based on structured conversational AI content stored in content repository 145, as shown by way of example in FIG. 3. The engine may operate as the interface layer between downstream conversational systems and the content transformation pipeline, enabling real-time access to verified, contextually aligned question-answer pairs.

Query inferencing engine 150 may receive, as input, a user-submitted query or utterance along with optional metadata such as the user's context, device type, intent classification, or session history. In some implementations, the input may first be normalized or preprocessed to remove extraneous tokens, resolve pronouns, or apply entity disambiguation. The processed query may then be encoded using one or more language models to generate a query embedding that captures the semantic and syntactic properties of the input.

In certain embodiments, query inferencing engine 150 may implement a retrieval-based inference architecture in which the query embedding is compared against stored embeddings in content repository 145. This comparison may be performed using approximate nearest neighbor search, cosine similarity, or other high-dimensional vector search techniques. The engine may retrieve one or more candidate question-answer pairs or content blocks based on proximity in embedding space, document metadata filters, or hybrid keyword and vector retrieval logic.

In some embodiments, query inference engine 150 may generate a hyper-augmented query by concatenating the query embedding with embeddings of retrieved atomic content blocks. This concatenation produces a compound vector representation that enhances semantic coverage and contextual grounding for response generation models, enabling higher predictive accuracy in downstream inference.

In some implementations, query inferencing engine 150 may include a re-ranking component that evaluates candidate responses using additional features such as relevance score, topic match, or user profile compatibility. The re-ranking model may be implemented as a shallow feedforward network, a cross-encoder, or a language model trained to score semantic alignment between the query and candidate responses. The highest-ranking result may be selected as the final response or passed to a response generation layer.

Query inferencing engine 150 may also support generative augmentation by conditioning a response generation model on the retrieved content and the user query. In this configuration, the retrieved response may be refined, contextualized, or reformatted into a new response using decoder-only or encoder-decoder models. The final output may preserve the factual basis of the retrieved answer while improving fluency, personalization, or stylistic fit based on delivery context.

In enterprise implementations, query inferencing engine 150 may further support explainability features, such as providing traceability links to the original content block, the source document, or the associated metadata that informed the selected response. This functionality may enhance user trust and regulatory compliance in domains such as legal, healthcare, and finance.

In regulated deployments, the inclusion of provenance metadata and confidence scoring in each automated response enables compliance with auditing frameworks and facilitates human oversight by providing interpretable explanations of response derivation.

The output of query inferencing engine 150 may include a contextually relevant, semantically accurate response to the user query, optionally accompanied by metadata such as confidence scores, topic labels, or attribution details. This output may be returned to a chatbot interface, embedded widget, or external application that presents the content to the end user in real time.

1.55 Visual Display layer or API Gateway

Visual display layer or API gateway (not shown) may be configured to facilitate interaction between external systems and the structured conversational AI content generated and managed by system 100. This component may expose content through graphical user interfaces or programmatic endpoints, enabling integration with client applications, agent platforms, and conversational interfaces that deliver the question-answer content to end users.

In some implementations, visual display layer or API gateway may be deployed as a frontend user interface, allowing content authors, reviewers, or business stakeholders to visualize the question-answer pairs generated from source materials. The interface may present generated questions and answers in alignment with the original content blocks, display associated metadata such as topics, confidence scores, or rephrasing variants, and support review or override workflows. The interface may allow users to filter content by document, content type, or generation status, and may support in-place editing or tagging of content items.

Alternatively, or in addition, API gateway may expose one or more RESTful or GraphQL APIs that allow external applications to submit user queries, retrieve responses, or manage content lifecycle operations. For example, a chatbot system may issue a GET request with a user query payload, and API gateway 155 may route the request to query inferencing engine 150, retrieve a relevant response, and return it in a structured format such as JSON. The API may also support content ingestion, review annotation submission, or the export of approved content for integration into customer-facing systems.

In certain embodiments, visual display layer or API gateway may include role-based access controls to enforce permissions around content visibility, modification rights, or usage limits. These controls may ensure that only authorized users or systems may access sensitive enterprise content or initiate actions that affect the state of the repository. For example, review decisions may only be made visible to designated quality assurance personnel, while query endpoints may be rate-limited for performance management.

Visual display layer or API gateway may also include diagnostic and observability features such as usage logging, query traceability, or performance dashboards. These tools may allow system operators to monitor the effectiveness and coverage of the deployed content, track query patterns, or identify content gaps based on user behavior.

The output of visual display layer or API gateway may include rendered or serialized representations of question-answer content, styled and formatted for use within conversational UI frameworks, voice agents, or enterprise knowledge portals. In cases where the component operates in API-only mode, it may serve as the integration bridge between system 100 and external AI orchestration platforms or enterprise software environments.

### 2. Method for Content Transformation & Response Retrieval

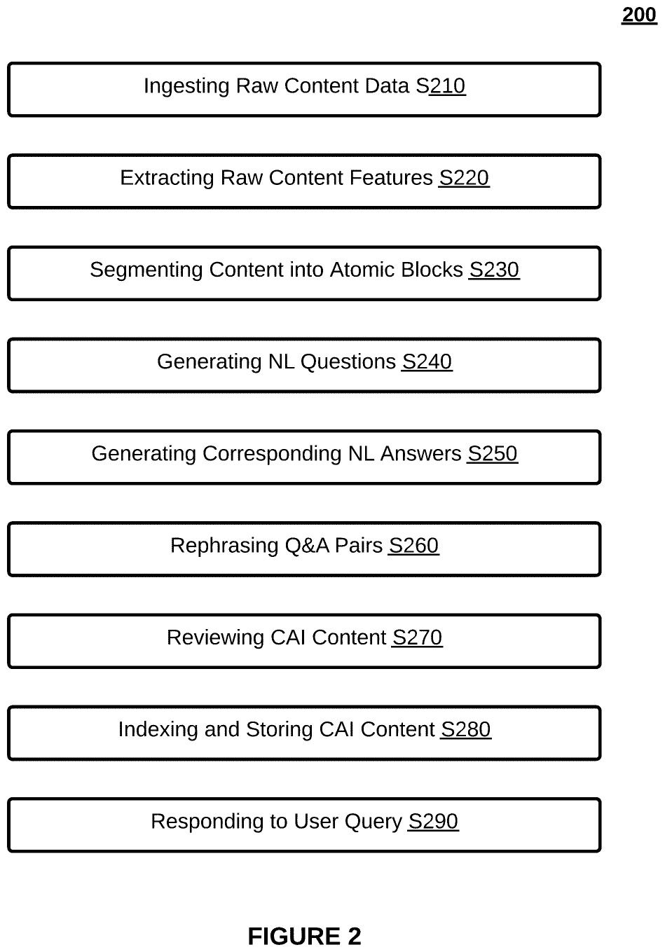

As shown by way of example in FIG. 2, a method 200 for generating conversational AI content from human-readable source material includes ingesting raw content from structured and unstructured document sources S210, extracting content features using layout-aware and language model encoders S220, segmenting the enriched content into atomic content blocks S230, configuring segmentation settings based on domain-specific rules or input profiles S232, generating natural language questions using generative language models S240, generating corresponding answers conditioned on the content block and question S250, rephrasing the question and answer pairs to align with tone, delivery channel, or user persona S260, reviewing the generated content for semantic correctness, fluency, and traceability S270, indexing and storing the approved content in a structured content repository S280, and responding to user queries by retrieving and optionally reformatting stored content S290.

Method 200 may be implemented to transform source content into structured, queryable conversational data by applying a sequence of configurable, AI-driven operations. The method may operate over various types of input materials, including structured documents, unstructured text, and hybrid data formats, to produce high-quality question-answer pairs suitable for use in enterprise-grade virtual agents, chatbots, or search-response systems. Each step of method 200 may be executed using specialized modules, including language models, content classifiers, and rephrasing agents, and may incorporate both automated and human-in-the-loop decision paths. The resulting method flow may facilitate ingestion, segmentation, generation, quality assurance, storage, and deployment of conversational units, enabling scalable and repeatable transformation of domain-specific content into AI-ready knowledge assets.

One technical advantage of the disclosed system is the use of a layout-aware, feature-rich content processing pipeline that combines positional, visual, and linguistic embeddings to transform complex documents into machine-interpretable atomic content blocks. Unlike traditional text parsing or rule-based document systems, the system dynamically incorporates layout vectors, semantic classification outputs, and transformer-based embeddings to produce structurally aligned representations that are both context-aware and format-agnostic. This provides a significant improvement in the fidelity and semantic resolution of content interpretation across varied enterprise documents.

Another technical benefit is the modular, configurable segmentation engine that enables domain-specific tuning and dynamic segmentation strategies based on document type, tone, or hierarchy. This approach overcomes limitations of static rule-based systems that often fail to generalize across content formats. In certain embodiments, segmentation modules are configured through rule sets, model weightings, or user annotations, resulting in deterministic and auditable segmentation aligned with downstream use cases.

Further, the disclosed system includes a question-answer generation architecture that is specifically tailored for content transformation rather than open-ended question answering. Each question is semantically derived from an atomic content block through structured conditioning, and each answer is either extracted or generated in a manner that preserves alignment to the source. This architecture ensures that all responses are traceable to their original content, supporting trust and regulatory compliance. These elements differ substantially from prior generic AI models and represent a concrete technological improvement in QA generation workflows.

From a deployment perspective, the disclosed method includes specific mechanisms for content review, approval, and traceability, ensuring that each question-answer pair carries metadata including version control, confidence scores, model lineage, and reviewer annotations. These mechanisms not only support explainability and governance but also satisfy technical system constraints in enterprise environments, including the need for data provenance, compliance with content audit trails, and real-time model observability.

In contrast to abstract idea claims, the steps of method 200 are rooted in computer technology and yield a result that is technological in nature, namely, the generation of machine-usable, semantically aligned, and structurally indexed conversational content from human-readable documents through a defined computational pipeline. The claimed system is not merely automating manual practices using generic computing resources; rather, it introduces a concrete implementation involving model-based feature extraction, layout-preserving segmentation, content-conditioned generative modeling, and domain-configurable processing modules that are not conventional, routine, or well-understood.

### 2.1 Ingesting Raw Content

S210, which includes ingesting raw content, may function to initiate the content transformation pipeline by acquiring human-readable source material from structured and unstructured data formats, the content comprising document text, layout metadata, or embedded objects intended for downstream processing. Step S210 may include receiving one or more content items in a human-readable format from one or more source systems or content repositories. The received content may include structured formats such as spreadsheets, tables, and XML, as well as unstructured or semi-structured formats such as PDF documents, DOCX files, plain text files, webpages, HTML, or scanned image-based content. The ingestion process may be initiated via manual upload, batch synchronization, or an API-based integration with external content management systems.

During step S210, the content may be parsed and normalized to extract text, layout features, and metadata. For example, a PDF ingestion routine may extract token sequences along with font attributes, bounding box coordinates, page identifiers, and section break indicators. Similarly, a spreadsheet ingestion routine may parse individual cells, infer header associations, and capture row-column alignments for downstream structural interpretation. Where applicable, the ingestion process may include an optical character recognition (OCR) stage to convert image-based content into machine-readable tokens.

In some implementations, the ingestion process performed in step S210 may include a content-type detection phase that determines whether the input corresponds to a policy document, product manual, FAQ, terms of service, or other domain-specific category. This classification may be determined using a lightweight classifier or document template heuristic and may be stored as metadata to influence downstream segmentation and generation logic.

Step S210 may produce a normalized intermediate representation that includes text content, token positions, formatting indicators, and content-level metadata. This representation may be persisted in memory or passed as input to step S220 for feature extraction. In some configurations, step S210 may support streaming ingestion for high-throughput content processing, buffering intermediate output in a message queue or staging area prior to downstream operations.

### 2.2 Extracting Content Features

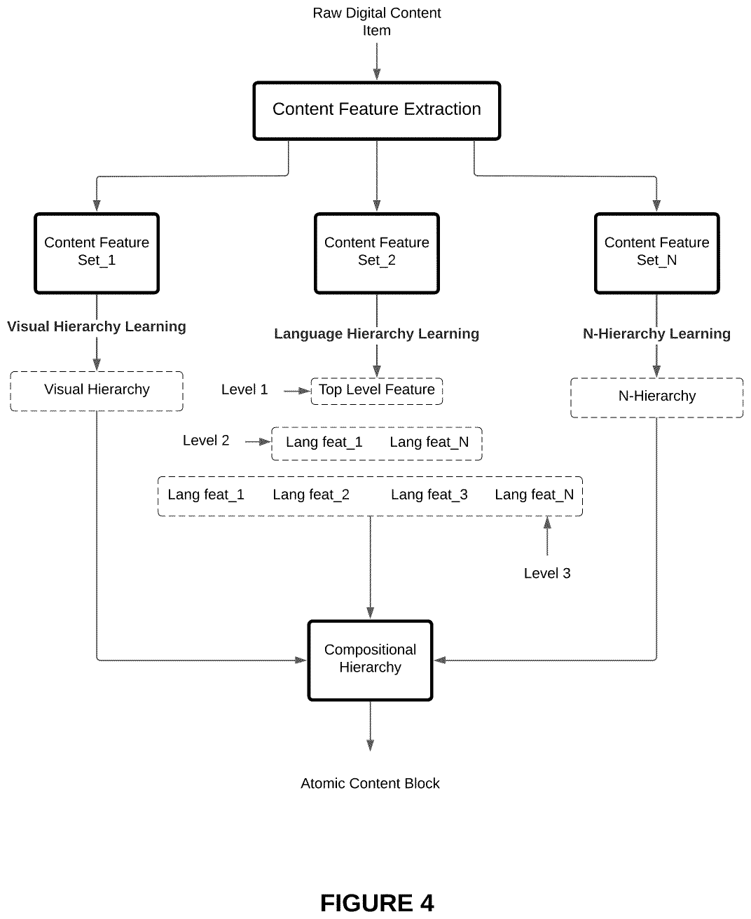

S220, which includes extracting content features, may function to transform normalized content into feature-enriched representations, as shown by way of example in FIG. 4, by applying language model embeddings and layout-aware annotations, the output comprising token-level and block-level vectors that preserve both semantic and structural characteristics. Step S220 may include deriving structural, linguistic, and contextual features from the normalized content representation generated during step S210. This feature extraction process may be used to construct token-level, sentence-level, or block-level embeddings that capture layout, semantics, syntax, and visual attributes of the ingested content. These features may be utilized in downstream steps such as segmentation, classification, question generation, and answer generation.

In some implementations, step S220 may apply a multi-modal analysis that incorporates both visual layout features and natural language features. Visual layout features may include font size, font weight, indentation level, spatial grouping, line spacing, and relative positioning on the page. These features may be encoded as positional embeddings or layout vectors that are aligned with the corresponding textual tokens. For example, a heading may be identified based on its font size and vertical spacing, while a table cell may be associated with its row-column coordinates and adjacent header labels.

Linguistic features may be derived using pretrained language models such as BERT, ROBERTa, LayoutLM, or custom transformers trained on enterprise document corpora. These models may tokenize the input text and compute contextualized embeddings that encode syntactic dependencies, semantic relationships, and topic relevance. The token embeddings may reflect inter-sentence dependencies, paragraph-level context, or document-wide themes. Additional linguistic features such as part-of-speech tags, named entity recognition outputs, and dependency parse structures may also be included in the feature set.

In some embodiments, step S220 may compute higher-order representations, such as content block embeddings, by aggregating token-level features using pooling operations, attention-based summarization, or recurrent encoding. These block embeddings may be used for later segmentation (step S230), classification, and similarity comparison tasks.

Step S220 may also extract auxiliary metadata from the content, such as section numbering, hyperlink structure, or document hierarchy cues, which may help preserve structural fidelity and enable alignment with original source formatting. This metadata may be encoded and associated with each content unit to support traceability and reuse across modules.

In certain implementations, the system may extract layout-level features from the raw digital content item, including spatial positioning (e.g., bounding box coordinates), font styles, and visual alignment information. These features may be input into a hierarchy-learning engine that learns a visual hierarchy indicative of the visual structure of the document. For example, headers, subheaders, and body text may be mapped to distinct levels based on indentation, size, and alignment, contributing to the compositional hierarchy used for generating atomic content blocks. A compositional hierarchy, as used herein, refers to a structured representation of content in which linguistic, structural, and visual features are combined into multi-level embeddings. The hierarchy may span tokens, sentences, paragraphs, and sections, and is recursively concatenated to preserve context across levels.

The output of step S220 may include a set of content tokens enriched with feature vectors, one or more block-level embeddings, and visual or structural annotations. These outputs may be passed to step S230 for segmentation into atomic content blocks.

2.3 Segment Content into Atomic Content Blocks

S230, which includes segmenting into atomic content blocks, may function to partition the enriched document content into minimally sufficient information units by identifying logical or semantic boundaries, each atomic content block corresponding to a standalone conversational unit suitable for question generation. Step S230 may include partitioning the enriched content into one or more atomic content blocks, each representing a discrete unit of meaning suitable for independent processing in subsequent question and answer generation steps. The segmentation process may be informed by both the structural and semantic features extracted during step S220 and may be implemented using a combination of machine-learned models, layout heuristics, and rule-based logic.

An atomic content block may correspond to a paragraph, sentence group, table row, list item, or any other self-contained segment that conveys a distinct concept or information unit. The objective of step S230 is to isolate such blocks in a way that preserves contextual coherence while maximizing the utility of each block for downstream generation. For example, a paragraph that introduces a key eligibility criterion may be segmented into a standalone block, while a multi-sentence definition may be treated as a single unit to preserve the scope of the explanation.

In some embodiments, step S230 may apply a segmentation model trained to detect logical content boundaries based on token-level and block-level embeddings. The model may be a sequence labeling model, such as a BiLSTM with CRF decoding, or a transformer-based classifier that predicts segment boundaries. These models may operate on feature-enriched token sequences, using both positional and semantic signals to determine where one block ends and another begins. Visual cues such as line breaks, indentation, bullet symbols, and heading formats may be incorporated into the model's attention mechanisms or embedding inputs to improve segmentation precision.

In some embodiments, the segmentation model includes one or more feed-forward layers that operate on the embeddings of the set of extracted features to generate segmentation outputs for partitioning the content. The embeddings, which may include token-level linguistic vectors, layout vectors, and other feature encodings, are provided as inputs to the feed-forward layers, which perform weighted linear transformations followed by non-linear activation functions. The feed-forward layers project the input embeddings into a latent feature space optimized for detecting semantic boundaries, visual structure transitions, or other hierarchical markers in the raw content.

In one implementation, the weights of the feed-forward layers are initialized using pretrained parameters from a language model and subsequently fine-tuned during a training phase using a labeled dataset of segmented content. During this phase, backpropagation may be used to compute gradients of a loss function (e.g., cross-entropy loss) with respect to the layer weights, and the weights are iteratively updated using an optimization algorithm such as stochastic gradient descent or Adam. In some cases, the model may operate in a frozen-weight configuration where the feed-forward layers use fixed pretrained weights to perform segmentation without additional tuning. In other cases, active learning modes may be employed, where human-in-the-loop feedback on segmentation outputs triggers incremental weight updates, refining the segmentation boundaries over time.

These feed-forward operations enable the segmentation model to learn multi-level semantic and structural hierarchies within the content, which are integrated into the compositional hierarchy used to generate the atomic content blocks.

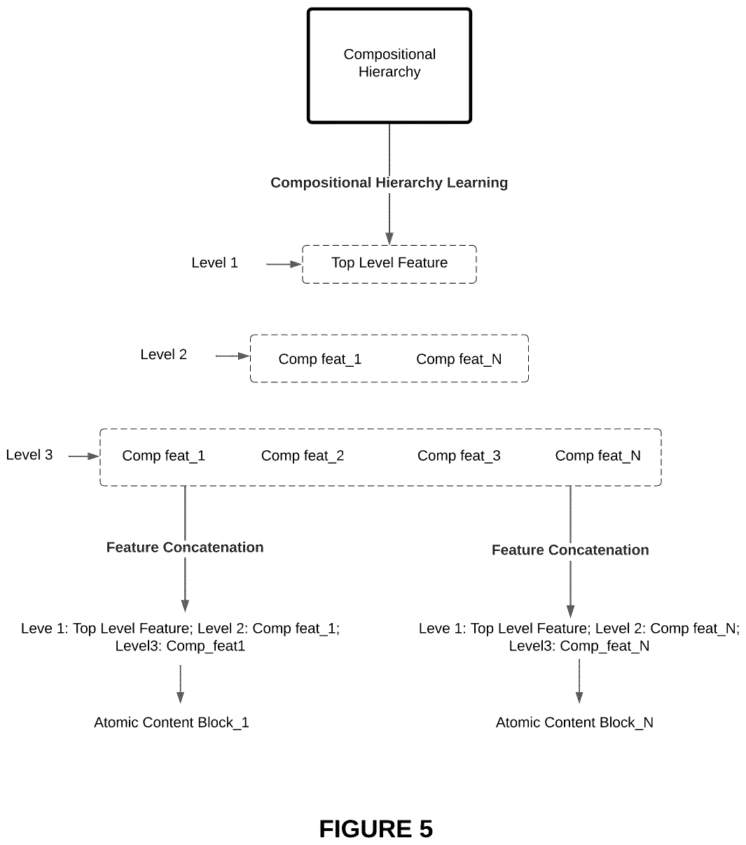

To form atomic content blocks, the system may concatenate embedding vectors of a given piece of content (e.g., a paragraph or a sentence) with embedding vectors from its antecedent levels in the compositional hierarchy, as shown by way of example in FIG. 5. The hierarchical concatenation ensures that each atomic content block contains contextual embeddings representing both the content and its broader structural context, enabling the atomic content block to semantically stand alone in response generation tasks.

In certain implementations, the compositional hierarchy may be formed by recursively concatenating embeddings at multiple granularity levels, token, sentence, and section, spanning both linguistic and visual dimensions. This hierarchical embedding structure allows atomic content blocks to retain multi-level semantic context, enhancing their standalone interpretability during query-response inference.

In alternative implementations, segmentation may be performed using a rule-based engine that applies configurable heuristics based on content structure, such as splitting content at headings, numbered lists, or section dividers. The segmentation logic may be guided by metadata derived during step S220, including heading levels, font sizes, or document schema annotations. These rule-based approaches may be used independently or in combination with model-based techniques to support domain-specific or fallback behaviors.

Step S230 may also support hierarchical segmentation, in which atomic content blocks are nested within higher-order blocks representing document sections or logical groupings. In such cases, parent-child relationships may be maintained to facilitate context-aware generation and response aggregation. Segment identifiers, ordering indices, and traceability metadata may be assigned to each block to support alignment with the original source content.

The output of step S230 may include a set of atomic content blocks, each represented as a self-contained unit associated with a sequence of tokens, embeddings, layout features, and structural metadata. These segmented blocks may be passed to optional step S232 for configuration-driven adjustment or directly to step S240 for question generation.

### 2.32 Configuring Segmentation Model

S232, which includes configuring segmentation settings, may function to tailor the segmentation process to domain-specific requirements by applying adjustable parameters or rule-based overrides, the configuration comprising segmentation profiles, content heuristics, or style-specific logic inputs. Step S232 may include optionally modifying or customizing the behavior of the segmentation logic executed in step S230 through configurable parameters, domain-specific rules, or user-specified directives. This configuration step may be performed prior to or concurrently with the segmentation process and may enable fine-tuning of how atomic content blocks are identified, grouped, or split based on document type, content source, or intended use case.

In some implementations, step S232 may involve loading a segmentation configuration file or rule set that defines criteria for boundary detection, such as minimum or maximum block length, allowable line break thresholds, or content type-specific segmentation strategies. For instance, a policy document may require segmentation at clause boundaries, while a product FAQ may use heading markers or topic shifts as primary segmentation cues. The configuration may specify whether tables are segmented row-wise or column-wise and may define tolerance thresholds for grouping short sentences into longer semantic units.

Step S232 may also support model-specific configuration, such as selecting between multiple segmentation models or adjusting model hyperparameters like confidence thresholds or attention span. In one example, a transformer-based segmentation model may expose a tunable parameter that controls the sensitivity to semantic boundary detection, which may be adjusted based on the domain or format of the input document.

In certain embodiments, step S232 may incorporate user-defined overrides, such as custom labels or markup embedded within the source content to direct segmentation behavior. These overrides may include tags that signal the start or end of a logical block, instruct the system to merge or ignore specific lines, or identify regions of interest to be preserved intact. Such instructions may be interpreted by the segmentation module to enforce or relax default boundary logic in specific contexts.

Step S232 may also allow for dynamic adjustment of segmentation rules based on real-time classification of the document type or content structure. For example, during step S210 or step S220, the system may detect that a document contains regulatory compliance information, prompting the use of a stricter segmentation profile that avoids truncating legal clauses or disclaimers.

The output of step S232 may be a set of configuration directives or model parameters that are applied by the segmentation module in step S230, influencing how the content is divided into atomic content blocks. This optional step may provide a mechanism for customizing the segmentation behavior of the system while maintaining consistency with domain-specific standards or operational requirements.

### 2.4 Generating Questions

S240, which includes generating questions, may function to convert each atomic content block into a natural language interrogative by invoking a generative language model, the output comprising a question that semantically aligns with the source content and adheres to style, tone, or specificity constraints. Step S240 may include generating one or more natural language questions corresponding to each atomic content block segmented in step S230. The purpose of this step is to convert declarative or informational content into interrogative form, enabling structured conversational AI systems to support user-driven query and response interactions based on the underlying source material.

Step S240 may receive, as input, one or more atomic content blocks along with associated features and metadata derived from prior steps, including token-level embeddings, content-type classifications, hierarchical position, and contextual descriptors. The generation of questions may be implemented using one or more generative language models, such as encoder-decoder transformer architectures trained to produce fluent and semantically relevant questions from textual inputs. Suitable models may include BART, T5, FLAN-T5, GPT variants, or domain-specific encoder-decoder models trained on question-answer corpora.

In one implementation, the atomic content block may be passed to an encoder module that produces a dense content embedding capturing the semantics and structure of the input. This embedding may be provided to a decoder module that autoregressively generates a token sequence representing the natural language question. The decoder may be conditioned not only on the content embedding but also on additional control signals such as domain, tone, desired specificity level, or content-type indicator. For example, a content block identified as a definition may yield a “What is . . . ” question, while a block describing conditions may yield a “When does . . . ” or “Under what circumstances . . . ” question.

In some cases, multiple candidate questions may be generated for a single content block, each targeting a different aspect of the information or varying in linguistic form. Step S240 may include a scoring or filtering mechanism to select the most fluent, informative, or appropriately scoped question. This may be accomplished using confidence scores from the model, semantic similarity measures, or post-generation ranking heuristics that assess alignment with the source content.

Step S240 may also include logic for bypassing question generation in certain scenarios. For example, if the content block already contains a well-formed question, such as in FAQ documents, the system may detect and preserve the original question instead of regenerating it. Similarly, if the content block does not contain interrogable information, such as internal references, legal notices, or footers, the system may exclude it from question generation to avoid introducing irrelevant content.

The output of step S240 may include one or more natural language questions associated with each atomic content block, each question optionally annotated with generation method, confidence score, model identifier, and traceability information linking it back to the original content source. These questions may be passed to step S250 for answer generation.

### 2.5 Generating Answers

S250, which includes generating answers, may function to synthesize a response to each generated question by conditioning on the corresponding content block, the answer comprising either an extractive span or an abstractive statement derived using a decoding architecture with feedforward and attention mechanisms. Step S250 may include generating a natural language answer for each question produced during step S240, based on the content of the corresponding atomic content block. The goal of this step is to synthesize or extract a concise, accurate, and contextually grounded answer that can be paired with the generated question to form a usable conversational unit for downstream deployment in a query-response system or chatbot interface.

Step S250 may receive, as input, a pairing of a generated question and its associated atomic content block, along with metadata including token-level embeddings, content-type classification, and traceability indicators. The answer generation process may be performed using a generative language model or a hybrid system that supports both extractive and abstractive response modes. Suitable models for answer generation may include autoregressive transformer decoders such as GPT-3.5, GPT-4, FLAN-T5, UL2, or retrieval-augmented generation models that incorporate explicit context references.

In some implementations, the input question and content block may be embedded separately or jointly using a cross-attention or dual-encoder architecture. The model may apply attention over the content block to identify relevant portions and may synthesize a grammatically fluent and semantically aligned answer using a decoder module. If the model operates in an extractive mode, it may identify a span or subset of tokens within the content block as the answer. If the model operates in an abstractive mode, it may rephrase or summarize the relevant information to generate a more conversational or user-friendly response.

The inference phase of step S250 may include the use of transformer layers with self-attention and cross-attention mechanisms that allow the model to dynamically focus on salient parts of the content block during generation. Feedforward layers may be applied after each attention sublayer to transform hidden states and refine the decoding output. The generated answer tokens may be sampled using decoding strategies such as greedy decoding, beam search, or nucleus sampling to balance fluency and diversity.

In certain embodiments, step S250 may generate multiple candidate answers for a given question and apply ranking logic based on generation confidence, length constraints, semantic similarity to the source block, or external verification signals. The top-ranked answer may be selected for use or forwarded to step S260 for optional rephrasing. In some configurations, hallucination detection logic may be applied to the generated answer to evaluate whether the content introduces information not grounded in the atomic content block, and to flag or suppress such outputs.

In some cases, the system may detect structured labels or metadata annotations associated with a segment of raw content indicating a canonical or pre-authored answer. In response, the system may bypass the answer generation phase and link the associated atomic content block to the specified canonical answer, ensuring consistency and avoiding unnecessary duplication.

The output of step S250 may include a finalized or candidate answer for each generated question, optionally annotated with confidence scores, alignment vectors, source references, and model provenance information. These question-answer pairs may then be passed to step S260 for optional linguistic rephrasing or directly to step S270 for quality review.

### 2.6 Rephrasing Content or Q/A Pairs

S260, which includes rephrasing content, may function to generate stylistic variants of the original question or answer by transforming surface form without altering semantic meaning, the rephrased content comprising alternate phrasings adapted to user persona, tone profile, or platform constraints. Step S260 may include optionally rephrasing one or more generated questions, answers, or question-answer pairs to produce alternate surface forms that maintain the original semantic meaning while adjusting tone, structure, or phrasing for consistency, clarity, or stylistic fit. This step may be used to generate linguistically diverse variants, enforce organizational voice standards, or optimize content for specific user personas or delivery channels.

Step S260 may receive, as input, a question-answer pair generated in steps S240 and S250, along with contextual metadata such as domain classification, stylistic preferences, or user-defined rephrasing objectives. The rephrasing process may be implemented using one or more natural language generation models trained to perform paraphrasing, style transfer, or tone adaptation. Suitable models may include BART, T5, GPT-4, or other encoder-decoder or decoder-only architectures configured for conditional text transformation.

In some implementations, the rephrasing model may receive both the original content and a style-conditioning input, such as a tone descriptor, user persona label, or format constraint. The model may encode the input sequence using a contextual embedding mechanism, then generate a linguistically distinct output using autoregressive decoding. The output may preserve the semantic content of the original question or answer while modifying sentence structure, lexical choice, or rhetorical framing.

In some embodiments, the style adaptation module may utilize control tokens or conditional embeddings to enforce stylistic constraints such as formality level, brand voice consistency, or channel-specific limitations (e.g., SMS character limits). These conditioning mechanisms enable fine-tuned rephrasing aligned with enterprise communication requirements.

Step S260 may be applied independently to questions, answers, or both, and may support multiple rounds of rephrasing. For example, the system may first generate a direct answer in step S250, then apply a style-optimized rephrasing for voice assistant deployment, followed by a further rephrasing for SMS channel constraints. Each variant may be stored with associated style labels, version identifiers, and links to the original content for traceability.

In certain embodiments, step S260 may generate multiple candidate rephrasings and score them using semantic similarity metrics, fluency measures, or user-defined preference models. The system may select the highest-quality variant for downstream deployment or preserve all variants for manual review and curation. In cases where the rephrasing diverges significantly from the original meaning or introduces ambiguity, the system may flag the content for review in step S270.

It shall be recognized that the system implementing the method 200 may use a sequence-to-sequence language model to generate a natural language question conditioned on the content of each atomic content block. In response, a corresponding answer may be generated using a generative or extractive model. Additionally, a rephrasing module may adjust the stylistic tone of the question and answer to match predefined formatting constraints or tone preferences of the conversational interface. If the system detects a confidence score below a predefined threshold, a fallback process may bypass the generated pair and either retrieve a pre-authored Q&A pair from a curated library or trigger a human-in-the-loop review workflow. The review workflow presents the low-confidence pair and associated metadata in an interface for manual correction, approval, or rejection.

The output of step S260 may include one or more rephrased questions, answers, or full pairs, each associated with metadata identifying the rephrasing model used, transformation parameters applied, and semantic alignment score relative to the original. These rephrased units may be forwarded to step S270 for review and approval before being finalized into the content repository.

### 2.7 Reviewing Generated Content

S270, which includes reviewing generated content, may function to verify the quality, fidelity, and linguistic coherence of generated question-answer pairs using automated and manual techniques, the review comprising semantic alignment checks, hallucination detection, and approval workflows for content readiness. Step S270 may include performing an automated, human-in-the-loop, or hybrid review of the generated question-answer pairs and any rephrased variants to assess quality, accuracy, consistency, and alignment with source material. This review step may serve as a final quality control checkpoint before content is approved for use in downstream conversational AI applications or committed to long-term storage in the content repository.

Step S270 may receive, as input, question-answer pairs produced in steps S240 through S260, along with associated metadata such as confidence scores, generation method identifiers, alignment traces to the source atomic content block, and any stylistic annotations or rephrasing history. The review process may be performed using rule-based validators, independent language models acting as review agents, human reviewers via user interface components, or a combination thereof.

In some implementations, the system may first apply an automated review using a secondary language model that is independent from the generation model. This model may be prompted or instructed to assess the semantic correctness of the generated answer relative to the content block, evaluate whether the question is clearly formulated and contextually appropriate, and detect any hallucinated or unsupported claims. Chain-of-thought prompting, entailment verification, and semantic entailment scoring may be employed to detect subtle misalignments between generated responses and source material.

Where configured, step S270 may initiate a human-in-the-loop review process. Reviewers may be presented with a graphical interface showing the source content, the generated question and answer, and any rephrased versions. The interface may allow reviewers to approve, reject, edit, or comment on the content. Reviewer decisions may be logged along with timestamps, rationale annotations, and reviewer identity for traceability. In some embodiments, reviewer actions may be used to generate fine-tuning signals or reinforcement feedback for model refinement in future iterations.

Step S270 may also support structured scoring or rubric-based evaluation frameworks. Each question-answer pair may be assigned a score or label corresponding to clarity, factual accuracy, language quality, stylistic alignment, or regulatory compliance, depending on the operational domain. These scores may be used to prioritize additional review, trigger reprocessing through prior steps, or inform downstream ranking and deployment strategies.

Accordingly, in some embodiments, a confidence evaluation module may assign a confidence score to each generated question and answer pair. When the score falls below a predefined threshold, the system may either (i) select a fallback Q&A pair from a curated content library or (ii) instantiate a review workflow. If review is triggered, the generated content, score, and associated embeddings are displayed in a graphical interface for review by a human editor. The editor may approve, modify, or reject the generated content using interactive controls provided within the reviewer interface.

In some embodiments, each generated response may include a system-calculated confidence value derived from probabilistic output layers of the underlying generative model or ensemble scoring. Additionally, provenance metadata may be attached, including atomic block identifiers, document origin, hierarchy level, and generation method, enabling downstream explainability, auditing, and compliance tracking. A confidence value, as used herein, refers to a numerical score or probability derived from one or more machine-learning models that quantifies the model's certainty in the accuracy of a generated question, answer, or automated response.

The output of step S270 may include a curated and optionally annotated set of question-answer pairs and their rephrased variants, marked as approved, flagged, or rejected. Approved items may be passed to step S280 for indexing and storage in the content repository. Flagged items may be cycled back to earlier processing steps, such as rephrasing (S260) or even re-generation (S240, S250), with updated parameters or fallback logic.

### 2.8 Indexing and Storing Rephrased Content in CAI Content Repository

S280, which includes indexing and storing in repository, may function to persist curated content in a searchable repository by associating each question-answer pair with vector embeddings and metadata, the repository comprising content identifiers, traceability attributes, and retrieval indices for later inference use. Step S280 may include storing the approved question-answer pairs and any rephrased variants in a structured content repository for later retrieval, serving, or integration into downstream conversational systems. This step may also include associating each stored content item with relevant metadata and indexing structures to support efficient semantic search, traceability, and content governance.

In one embodiment, the repository comprises a conversation AI (CAI) repository that includes a vector index structure configured to store and organize embedding vectors associated with each atomic content block. The vector index supports real-time, hardware-accelerated similarity-based retrieval operations using distance metrics such as cosine similarity, dot product, or Euclidean distance. A vector index, as used herein, refers to a structured data storage mechanism for organizing and enabling similarity-based retrieval of embedding vectors, implemented using hardware-accelerated search engines, approximate nearest neighbor search algorithms, or other optimized indexing techniques. This enables fast and accurate lookup of relevant content blocks during the response generation phase.

In some embodiments, the vector index may be implemented using hardware-accelerated search engines, such as GPU-based approximate nearest neighbor (ANN) search frameworks or FPGA-optimized indexing structures, which significantly reduce latency and enable real-time retrieval across large-scale repositories.

Step S280 may receive, as input, a set of reviewed and approved question-answer pairs, along with associated data including original content block references, hierarchical document structure, rephrasing history, scoring attributes, model provenance, and domain-specific annotations. Each item may be formatted into a standardized content object that encapsulates the question, answer, rephrased versions (if any), and metadata required for downstream filtering, querying, or content delivery.

In some implementations, step S280 may generate one or more vector embeddings for each content item using language model encoders such as Sentence-BERT, OpenAI embedding models, or domain-specific transformers. These embeddings may be stored alongside the raw text content and used to enable fast similarity-based retrieval during inference. Embeddings may represent the question, the answer, or a fused representation of the entire pair, depending on the configuration.

Step S280 may also involve assigning unique identifiers and version control metadata to each content item to support updates, rollbacks, or content lifecycle management. The system may track the generation date, last review timestamp, reviewer identity, and associated model version for each stored item. Items may be grouped into content collections or indexed by domain taxonomy, source document, content type, or deployment intent.

In certain embodiments, step S280 may support differential indexing schemes, such as keyword-based indexes, vector-space indexes, and metadata filters. These indexes may be optimized to allow efficient retrieval by query inferencing engine 150 or by external systems interfacing through API gateway 155. The indexing logic may also incorporate confidence thresholds, usage frequency data, or user feedback metrics to support ranked retrieval and adaptive content selection.

The output of step S280 may be a structured repository of finalized conversational content, including question-answer pairs and their associated metadata, stored in a form that is queryable, auditable, and deployable across a variety of interactive platforms. This repository may support real-time or batch querying for use in virtual assistants, enterprise chatbots, knowledge retrieval systems, or customer-facing portals.

### 2.9 Performing Inference on User Query (Retrieval)

S290, which includes responding to queries using stored content, may function to retrieve and optionally reformat approved content in response to a user query by executing a vector similarity or keyword search, the output comprising a semantically relevant response returned via a conversational interface. Step S290 may include receiving a natural language query from a user or system and retrieving a contextually appropriate response using the structured content stored during step S280. S290 enables real-time deployment of the generated question-answer pairs in production environments, including chatbots, virtual agents, search-response systems, or embedded conversational widgets.

Step S290 may receive, as input, a user-issued query along with optional contextual metadata such as session history, user persona, language preference, or device type. The system may preprocess the query to normalize formatting, resolve coreference or anaphora, and extract relevant entities or intent cues. The processed query may then be encoded into a dense vector representation using a semantic embedding model such as Sentence-BERT, a domain-optimized transformer encoder, or a dual-encoder retrieval model.

In some implementations, the query embedding may be compared against stored embeddings of previously generated questions in the content repository using similarity search algorithms such as cosine similarity or approximate nearest neighbor (ANN) search. The system may retrieve one or more top-ranked question-answer pairs that are semantically aligned with the query. Ranking heuristics may further refine the result set using relevance scores, topic filters, content type, or metadata constraints.

In some embodiments, each atomic content block stored in the CAI content repository is associated with a set of content embeddings, which are vector representations of the semantic and/or structural content of the block. During retrieval, a similarity-based matching process may be employed, wherein embeddings of an incoming query are compared to the content embeddings of stored atomic content blocks using a selected distance metric, such as cosine similarity, dot product, or Euclidean distance. The atomic content blocks with embedding vectors that satisfy a predefined similarity threshold relative to the query embeddings may be retrieved for use in generating the hyper-augmented query. A hyper-augmented query, as used herein, refers to a query representation that combines the embeddings of the original query with embeddings of one or more retrieved atomic content blocks, thereby expanding the semantic and contextual coverage used for inference.

In alternative or complementary configurations, step S290 may include cross-encoder re-ranking or entailment-based filtering to ensure that the retrieved question-answer pair accurately addresses the user's intent. For example, a cross-encoder model may jointly process the query and candidate pairs to produce a contextual match score, allowing the system to select the best-fitting result with higher confidence.

Step S290 may also support answer generation augmentation. In such cases, the retrieved answer may be reformulated or enriched using a language model conditioned on the query and the retrieved content. This generative enhancement may improve tone, personalization, or adaptiveness to the delivery channel while maintaining factual alignment with the stored source material.

The system may optionally generate and display supporting metadata with the response, such as the source content block, document origin, confidence score, or explanation trace. This feature may be particularly valuable in regulated or trust-sensitive domains, enabling users to trace responses back to authoritative documentation.

The output of step S290 may include a contextually relevant, semantically accurate, and fluently generated or retrieved answer that responds to the user's query, optionally paired with a reformulated version of the question, attribution metadata, or presentation instructions. This output may be returned to the calling interface, such as a web-based chatbot, voice assistant, or mobile application, for display or speech rendering to the user.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A computer-implemented method for improving a predictive accuracy of a machine learning-based automated response system, the method comprising:
implementing one or more computer processors executing a content data transformation phase including:
extracting, by a content feature extraction model, a set of content features from a raw digital content item based on an input of the raw digital content item into a segmentation module;
learning, by the segmentation module, a plurality of distinct hierarchies derived from the set of content features extracted from the raw digital content item;
deriving, by the segmentation module, a compositional hierarchical based on a combination of the plurality of distinct hierarchies;
forming one or more atomic content blocks based on implementing an antecedent concatenation of embeddings of a target piece of content with embeddings of content at antecedent levels of the compositional hierarchy;
storing and indexing each of the one or more atomic content blocks into a conversational artificial intelligence (CAI) content repository database;
implementing the one or more computer processors executing a query transformation phase including:
executing an automated conversational response system or a search-query automated response system;
receiving a query at an interface of the automated conversational response system or the search query automated response system;
converting the query into a set of query embeddings;
using the set of query embeddings to perform a CAI content lookup of the CAI content repository database;
retrieving at least one atomic content block from the CAI content repository database based on a completion of the CAI content lookup;
transforming the query into a hyper-augmented query based on a concatenation of embeddings of the at least one atomic content block to the query embeddings of the query;
implementing the one or more computer processors executing an inferencing phase including:
generating, in real-time by one or more response models trained on semantic embeddings, one or more response inferences based on an input of the hyper-augmented query into the one or more response models;
generating, in real-time, an automated response to the query using the one or more response inferences; and
completing the automated response to the query by returning, via the interface of the automated conversational response system or the search query automated response system, the response data.

2. The method according to claim 1, wherein performing the lookup of CAI content includes:
locating the at least one atomic content block, from within the CAI content repository database, by identifying one or more sets of content embeddings associated with each of the one or more atomic content blocks stored within the CAI content repository database, the one or more sets of content embeddings having a vector distance from the set of query embeddings that satisfies a vector similarity threshold.

3. The method according to claim 1, wherein extracting, by the content feature extractor, the set of content features includes:
extracting a set of linguistic features from the raw digital content item, wherein the linguistic features comprise token-level embeddings generated using a pretrained language model.

4. The method according to claim 3, wherein learning, by the segmentation module, the plurality of distinct hierarchies includes:
learning a language hierarchy based on the set of linguistic features associated with the raw digital content item.

5. The method according to claim 2, wherein extracting, by the content feature extractor, the set of content features further includes:
extracting a set of layout features from the raw digital content item, wherein the layout features comprise vectors of spatial positions, font attributes, and visual alignment indicators associated with tokens in the raw digital content item.

6. The method according to claim 5, wherein learning, by the segmentation module, the plurality of distinct hierarchies includes:
learning a visual hierarchy based on the set of layout features associated with the raw digital content item.

7. The method according to claim 1, wherein deriving, by the segmentation module, the compositional hierarchy includes:
integrating into the single compositional hierarchy a language hierarchy comprising a hierarchy of a set of linguistic features associated with the raw digital content item with a visual hierarchy comprising a hierarchy of a set of layout features associated with the raw digital content item.

8. The method according to claim 1, wherein each of the one or more atomic content blocks comprises a question-and-answer pair derived from a corresponding atomic content block of the raw digital content data, the atomic content block having been generated by segmenting the raw digital content data into semantically coherent units of embeddings or vectors using a segmentation model configured to evaluate at least one of linguistic embeddings, vectors of layout features, or vectors of structural markers associated with the raw digital content data item.

9. The method according to claim 1, wherein in response to the input of the raw digital content item, the content feature extraction model generates token-level and layout-level feature embeddings from the raw digital content data, the token-level and layout-level feature embeddings comprising one or more of semantic vectors, bounding box coordinates, font characteristics, or visual alignment features.

10. The method according to claim 1, wherein each of the one or more atomic content blocks comprises a complete semantic unit of vectors joined together based on antecedent relationships of the compositional hierarchy, wherein the complete semantic unit of vectors is designed to sufficiently respond to a potential query into the automated conversational response system or the search-query automated response system without additional contextual data.

11. The method according to claim 1, wherein implementing the one or more computer processors executing the raw content data transformation phase further includes:
generating, for each atomic content block of the one or more atomic content blocks, a natural language question using a sequence-to-sequence generation model conditioned on content of the atomic content block.

12. The method according to claim 11, wherein implementing the one or more computer processors executing the raw content data transformation phase further includes:
generating a corresponding natural language answer for each natural language question that was generated for the atomic content block using a generative or extractive model conditioned on the content of the atomic content block and the natural language question.

13. The method according to claim 12, wherein implementing the one or more computer processors executing the raw content data transformation phase further includes:
rephrasing, by a style adaptation module comprising a transformer-based model, the natural language question or the natural language answer with one or more predefined stylistic parameters of the automated conversational response system or the search query automated response system.

14. The method according to claim 1, wherein implementing the one or more computer processors executing the raw content data transformation phase further includes:
transforming the one or more atomic content blocks into CAI content by rephrasing, by a style adaptation module comprising a transformer-based model, the one or more atomic content blocks to align with one or more stylistic input parameters into the style adaptive module.

15. The method according to claim 1, wherein implementing the one or more computer processors executing the raw content data transformation phase further includes:
selectively bypassing a question generation step for the one or more atomic content blocks in response to detecting that the one or more atomic content blocks contains a predefined structured label or annotation specifying a pre-authored question.

16. The method according to claim 1, wherein implementing the one or more computer processors executing the raw content data transformation phase further includes:
selectively bypassing an answer generation step and linking a generated natural language question to an externally supplied canonical answer in response to identifying the one or more atomic content blocks as referencing document content containing a satisfactory answer.

17. The method of claim 1, wherein implementing the one or more computer processors executing the raw content data transformation phase further includes:
detecting that a generation model confidence value for a model-generated question or a model-generated answer is below a predefined threshold, and
in response to the detecting, bypassing a question-answer generation step and retrieving a fallback question-answer pair from a curated content library or automatically causing a review workflow for reviewing the one or more atomic content blocks,
wherein if the review workflow is instantiated:
presenting the model-generated question or the model-generated answer and the generation model confidence value within a reviewer interface, the reviewer interface providing one or more interface objects for approving, rejecting, or editing the model-generated question or the model-generated answer.

18. The method of claim 1, wherein the CAI content repository database includes a vector index:
storing and organizing content embeddings associated with the one or more atomic content blocks, and
enabling similarity-based retrieval of CAI content or the one or more atomic content blocks using a distance metric including one of cosine similarity, dot product, and Euclidean distance.

19. A computer system for improving a predictive accuracy of a machine learning-based automated response system, the system comprising:
one or more computer processors and a memory, wherein the memory includes a vector index structure configured to store embedding vectors and support real-time similarity-based retrieval using a hardware-accelerated search engine, the memory storing instructions that, when executed by the one or more computer processors, cause the system to:
execute a content data transformation phase comprising:
extracting, using a content feature extraction model, a set of content features from a raw digital content item based on an input of the raw digital content item into a segmentation module;
learning, by the segmentation module, a plurality of distinct hierarchies derived from the set of content features extracted from the raw digital content item;
deriving, by the segmentation module, a compositional hierarchy based on a combination of the plurality of distinct hierarchies;
forming one or more atomic content blocks based on an antecedent concatenation of embeddings of a target piece of content with embeddings of content at antecedent levels of the compositional hierarchy;
storing and indexing each of the one or more atomic content blocks into a conversational artificial intelligence (CAI) repository database;
execute a query transformation phase comprising:
executing an automated conversational response system or a search-query automated response system;
receiving a query at an interface of the automated conversational response system or the search-query automated response system;
converting the query into a set of query embeddings;
performing a CAI content lookup of the CAI content repository database using the set of query embeddings;
retrieving at least one atomic content block from the CAI content repository database based on a completion of the CAI content lookup;
transforming the query into a hyper-augmented query based on a concatenation of embeddings of the atomic content block with the query embeddings of the query;
execute an inferencing phase comprising:
generating, in real-time and by one or more response models, one or more response inferences based on an input of the hyper-augmented query into the one or more response models;
generating, in real-time, an automated response to the query using the one or more response inferences; and
completing the automated response to the query by returning, via the interface of the automated conversational response system or the search-query automated response system, the response data.

20. The system according to claim 19, wherein the content repository comprises a vector index implemented in memory, the vector index storing a plurality of embedding vectors associated with the atomic content blocks and configured to enable similarity-based retrieval operations based on a selected vector distance metric.

21. A computer-implemented method for generating automated responses using hierarchical content representations, the method comprising:
at a remote query-response service implemented by a distributed network of computers:
receiving raw digital content;
extracting, by a feature extraction module, a set of semantic and structural features from the raw digital content;
generating, by a segmentation model, one or more content representations structured according to at least one learned hierarchy derived from the extracted set of semantic and structural features;
forming a plurality of enriched content blocks based on contextual relationships identified within the at least one learned hierarchy;
storing the enriched content blocks in a content repository configured to enable similarity-based retrieval;
receiving a query via an interface of an automated response system;
converting the query into one or more query representations, including vector embeddings;
retrieving, from the content repository, one or more enriched content blocks relevant to the query representations;
generating an augmented query representation by combining the query representations with the retrieved one or more enriched content blocks;
providing the augmented query representation to a response generation engine;
generating, using the response generation engine, an automated response based on the augmented query representation; and
returning the automated response to a user interface.

22. A method according to claim 1, wherein the automated response includes a confidence value and provenance metadata identifying one or more given atomic content blocks used to construct the automated response.
